(19) United States
(12) Patent Application Publication
(10) Pub. No.: US 2016/0086197 A1
(43) Pub. Date: Mar. 24, 2016

(54) METHOD FOR ANALYZING SHOPPING PATTERN AND SYSTEM THEREIN

(71) Applicant: NATIONAL SUN YAT-SEN UNIVERSITY, Kaohsiung City (TW)

(72) Inventors: Chang-Chen Yang, Kaohsiung City (TW); You-Chiun Wang, Kaohsiung City (TW)

(21) Appl. No.: 14/568,376

(22) Filed: Dec. 12, 2014

(30) Foreign Application Priority Data
Sep. 22, 2014 (TW) 103132630

(51) Int. Cl. G06Q 30/02

(52) U.S. Cl. CPC G06Q 30/0201

(57) ABSTRACT

A method for analyzing shopping pattern includes providing a shopping pattern analyzing system having a cart and at least one commodity-communicating module; determining whether the cart moves or not via a sensing apparatus of the cart; determining whether a motionless time of the cart exceeds a predetermined time or not; determining whether the cart passes through a repeating area or not; and determining whether the user pushes the cart with one hand or two hands via two sensing members of the pushing portion. The present invention enables to analyze the shopping patterns of consumers at the moment the consumers shop to learn which commodities are interested by the consumers so as to perform customized promoting commodity notice for each of the consumers.

### FIELD OF THE INVENTION

The present invention is generally relating to a method for analyzing shopping pattern. The invention particularly represents the method for analyzing shopping pattern by way of cart operating conditions.

### BACKGROUND OF THE INVENTION

The shopping pattern analysis of ordinary supermarket is based on distinct consumption demands and consumption habits for each consumer to merely perform an overall statistical analysis. That means after a period of time, analyzing which ones are the popular commodities on the basis of sale quantity for commodity. Mentioned method is not able to perform customized commodity-sales-promotion to individual consumer. Accordingly, when a supermarket is in commodity-sales-promotion, all the promotion commodities can only be listed on a flier for providing consumers with more options. However, with diversified development of supermarket, the types of sale commodities in supermarkets are more and more increased. For instance, as little as a light bulb, or as large as a motorcycle, food, clothes, living, transportation, education, entertainment . . . etc can be seen in supermarket. Therefore, the quantity of the commodities listed in flier is getting increased as well so that consumers can not find out rapidly and clearly about whether commodities the consumers need are under sale promotion or not therefore influencing the desire of consumers for buying.

### SUMMARY

The primary object of the present invention is that when a user shops at a supermarket, analyzing whether the user is interested in a commodity the user just passes through via the state of a using cart, and performing to record the commodity that the user is interested in through a rear end server. Once the recorded commodity that the user is interested in is in special offer promotion, the supermarket may notify the consumers via the cart, message or mobile apparatus for related information of promoting commodities therefore effectively stimulating consuming desire.

A method for analyzing shopping pattern includes providing a shopping pattern analyzing system having a cart and at least one commodity-communicating module, wherein the cart comprises a pushing portion, a moving portion and a communication apparatus, the pushing portion comprises a handle and two sensing members, each of the sensing members is disposed at the handle, the moving portion comprises a moving member and a sensing apparatus, and the at least one commodity-communicating module corresponds to a commodity; determining whether the cart moves or not via the sensing apparatus, if the cart does not move, determining whether a motionless time of the cart exceeds a predetermined time or not, if the cart moves, determining whether the cart passes through a repeating area or not; determining whether the motionless time of the cart exceeds the predetermined time or not, if the motionless time of the cart does not exceed the predetermined time, judging a user of the cart is interested in the commodity that is corresponded to the at least one commodity-communicating module adjacent to the cart; determining whether the cart passes through the repeating area or not, if yes, judging the user of the cart is interested in the commodity that is in the repeating area and corresponded to the at least one commodity-communicating module adjacent to the cart, if not, determining whether the user pushes the cart with one hand or two hands; and determining whether the user pushes the cart with one hand or two hands via the sensing members of the pushing portion, if the user pushes the cart with two hands, judging the user is not interested in the commodity that is corresponded to the at least one commodity-communicating module adjacent to the cart, if the user pushes the cart with one hand, judging the user is interested in the commodity that is corresponded to the at least one commodity-communicating module adjacent to the cart.

By sensing whether the cart moves or not via the sensing apparatus, determining whether the motionless time of the cart exceeds the predetermined time or not, determining whether the cart passes through the repeating area or not via communication between the communicating apparatus of the cart and the at least one commodity-communicating module, and determining whether the user holds the handle with one hand or two hands via the sensing member of the pushing portion, the present invention enables to judge about whether the user is interested in the commodity that is corresponded to the at least one commodity-communicating module adjacent to the cart so as to perform individual shopping pattern analysis for each of the users. Therefore, it is more customized for the notices of commodities that are in promotion. Further, the notices of promotion commodities received by consumers will meet the needs of each consumer therefore stimulating consumption.

### DESCRIPTION OF THE DRAWINGS

FIG. 1 is a flow chart illustrating a method for analyzing shopping pattern in accordance with an embodiment of the present invention.

FIG. 2 is a perspective diagram illustrating a cart in accordance with the embodiment of the present invention.

FIG. 3 is a block diagram illustrating a shopping pattern analyzing system in accordance with the embodiment of the present invention.

FIG. 4 is a diagram illustrating a supermarket in accordance with the embodiment of the present invention.

FIG. 5 is a flow chart illustrating a notice for promoting commodity data in accordance with the embodiment of the present invention.

FIG. 6 is a perspective diagram illustrating a cart in accordance with the embodiment of the present invention.

FIG. 7 is a perspective diagram illustrating a cart in accordance with the embodiment of the present invention.

FIG. 8 is a block diagram illustrating a shopping pattern analyzing system in accordance with the embodiment of the present invention.

FIG. 9 is a block diagram illustrating a shopping pattern analyzing system in accordance with the embodiment of the present invention.

### DETAILED DESCRIPTION OF THE INVENTION

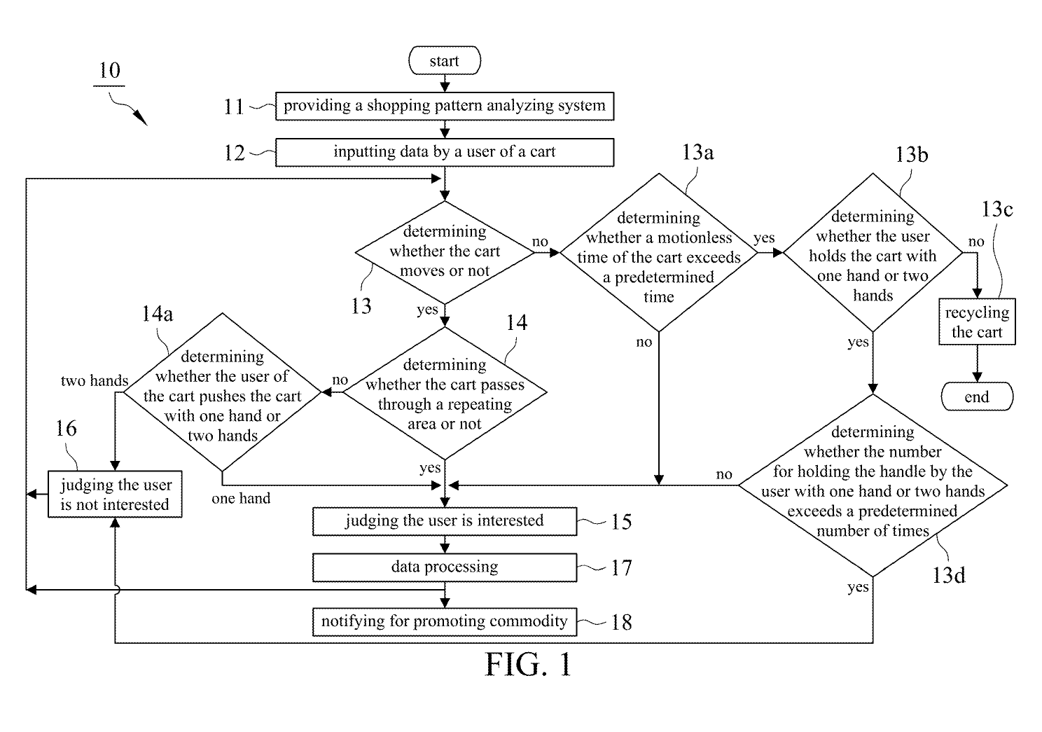

With reference to FIG. 1, a flow chart of a method for analyzing shopping pattern 10 in accordance with an embodiment of the present invention is illustrated. The method for analyzing shopping pattern 10 includes providing a shopping pattern analyzing system 11, inputting data by a user of a cart 12, determining whether the cart moves or not 13, determining whether the cart passes through a repeating area or not 14, judging the user is interested 15, judging the user is not interested 16, data processing 17 and notifying for promoting commodity 18.

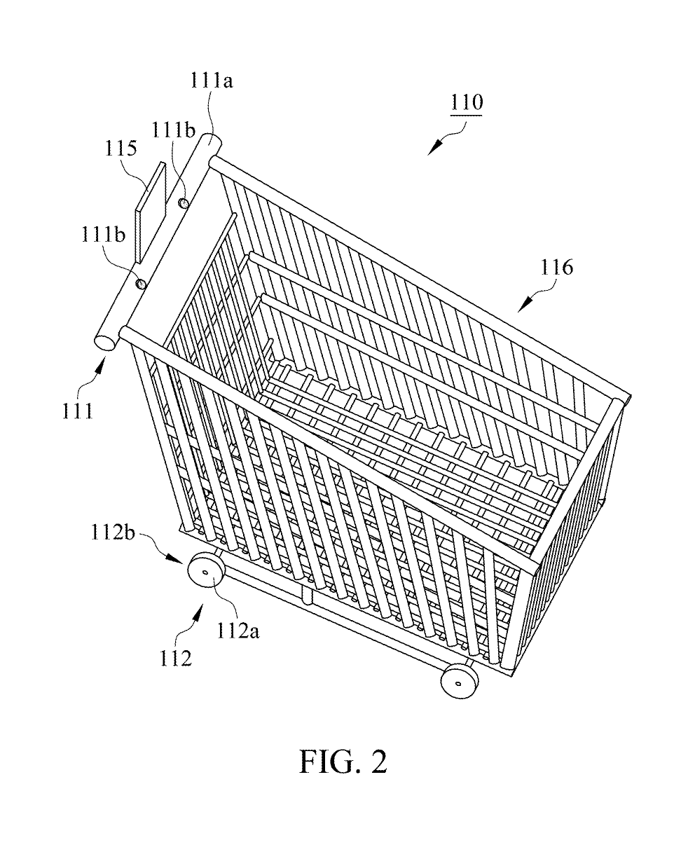

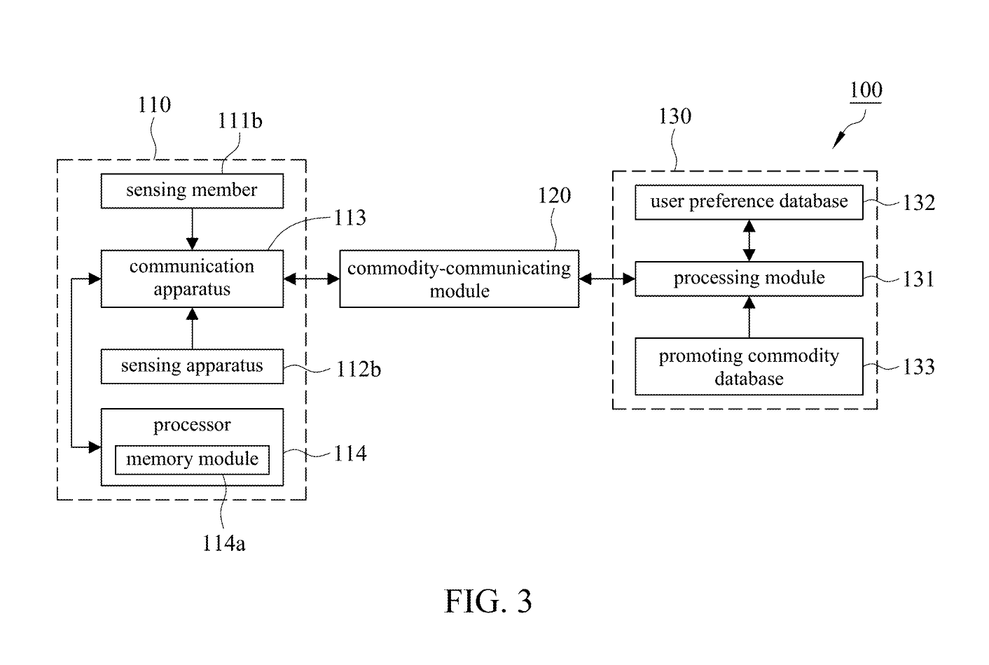

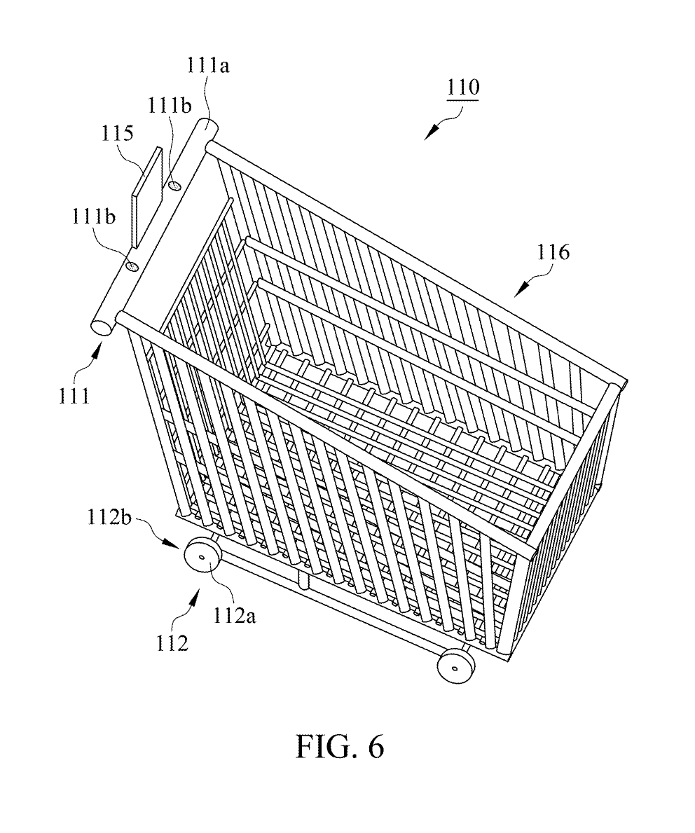

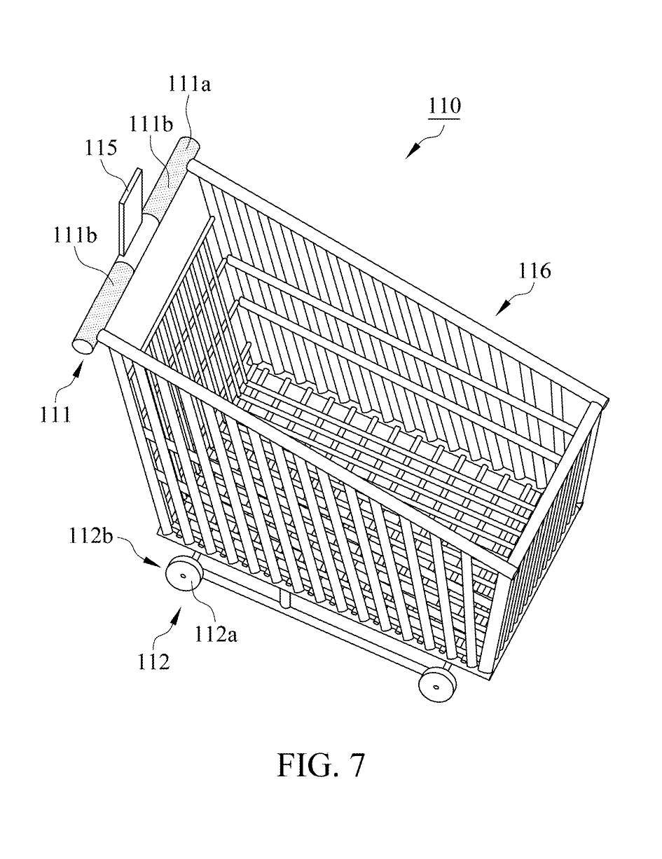

Referring to FIGS. 1, 2 and 3, providing a shopping pattern analyzing system 100 in the step 11 of providing a shopping pattern analyzing system, wherein the shopping pattern analyzing system 100 comprises a cart 110, at least one commodity-communicating module 120 and a server 130. Referring to FIGS. 2 and 3, the cart 110 comprises a pushing portion 111, a moving portion 112, a communication apparatus 113, a processor 114, an input/display module 115 and an accommodating portion 116. The pushing portion 111 comprises a handle 111a and two sensing members 111b, wherein the handle 111a is used by a user of the cart 110 for holding so as to push the cart 110, and each of the sensing members 111b is disposed at the handle 111a. The sensing members 111b are disposed separately at positions the user generally holds the handle 111a by right hand and left hand to determine whether the user holds the handle 111a of the cart 110 with one hand or two hands through the condition on how the sensing members 111b being touched by the user. With reference to FIG. 2, each of the sensing members 111b is a button. By the button pressed or not, the condition that the user holds the handle 111a is determined. Or referring to FIG. 6, each of the sensing members 111b is a light-sensing device. By the light-sensing device sensitive to light or not, the condition that the user holds the handle 111a is determined. Or referring to FIG. 7, each of the sensing members 111b is a touch device. By the touch device touched or not, the condition that the user holds the handle 111a is determined.

With reference to FIGS. 2 and 3, the moving portion 112 comprises a moving member 112a and a sensing apparatus 112b, wherein the sensing apparatus 112 is a G-Sensor or tachometer. The sensing apparatus 112 determines whether the cart 110 moves or not via sensing variation of gravity or rotation speed of the moving member 112a. The processor 114 enables to bury into the handle 111a or dispose on the handle 111a, in this embodiment, the processor 114 is buried into the handle 111a. The input/display module 115 is used for inputting and displaying data, wherein the input/display module 115 is a touch panel, and the accommodating portion 116 is used for accommodating commodities.

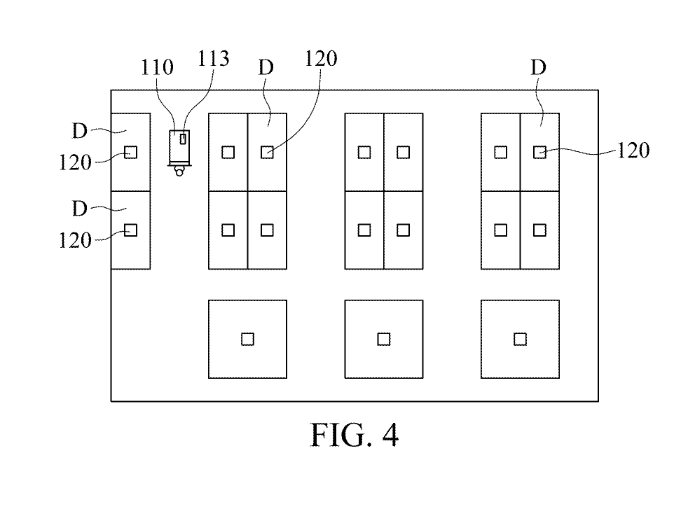

With reference to FIGS. 3 and 4, the commodity-communicating module 120 is disposed on a shelf D and corresponds to a commodity. The commodity-communicating module 120 is linked to the communication apparatus 113 of the cart 110 via a wireless communication, wherein the wireless communication is ZigBee, RFID or Bluetooth. The commodity is defined as a single commodity, a type of commodity or commodities in a region. By communication between the communication apparatus 113 of the cart 110 and the commodity-communicating module 120, which commodity having the short distance with the cart 110 is learned at present.

With reference to FIGS. 3, 8 and 9, the server 130 is linked to the commodity-communicating module 120 via wireless or wired communication, wherein the server 130 comprises a processing module 131, a user preference database 132 and a promoting commodity database 133. The processing module 131 is used for receiving the signals from the commodity-communicating module 120. The user preference database 132 is used for storing commodity data that the user is interested in and enables to update at each time the user shops. The promoting commodity database 133 is used for storing promotion commodity data in supermarket and enables to update at anytime by supermarket worker.

With reference to FIGS. 1 and 2, in the step 12 of inputting data by a user of a cart, the user of the cart 110 inputs the user data via the input/display module 115 to individually record shopping pattern of each user, wherein the user data includes name, day of birth, telephone, membership number and combinations therein.

With reference to FIGS. 1, 2 and 3, in the step 13 of determining whether the cart moves or not, the state of the cart 110 is sensed by sensing apparatus 112b, wherein a moving sense signal is outputted to the commodity-communicating module 120 via the communication apparatus 113, the commodity-communicating module 120 transmits the moving sense signal to the processing module 131 of the server 130 via wireless or wired communication, and the processing module 131 determines whether the cart 110 moves or not based on the moving sense signal. Or, referring to FIGS. 1, 2, 8 and 9, in the step 13 of determining whether the cart moves or not, the state of the cart 110 is sensed by sensing apparatus 112b, then the processor 114 identifies whether the cart 110 moves or not, the result on the state of the cart 110 is outputted to the commodity-communicating module 120 of the commodity via the communication apparatus 113, the commodity-communicating module 120 transmits the result to the processing module 131 of the server 130 via wireless or wired communication, eventually the processing module 131 may get over the movement of the cart 110 immediately. Besides, referring to FIGS. 1, 2, 3 and 8, the serial number or node name of the commodity-communicating module 120 communicated with the cart 110 is stored into a memory module 114a of the processor 114 of the cart 110 so as to be the basis for followed-up determination about whether the cart 110 passes through the repeating area or not. Or, referring to FIGS. 1, 2 and 9, the serial number or node name of the commodity-communicating module 120 communicated with the cart 110 is stored into a memory 131a of the processing module 131 of the server 130 so as to be the basis for followed-up determination about whether the cart 110 passes through the repeating area or not.

Referring to FIGS. 1, 2, 3, 8 and 9, once the processing module 131 or the processor 114 determines the cart 110 is not moving based on the moving sense signal in the step 13 of determining whether the cart moves or not, that is to say, when the gravity of the moving sense signal remains nearly unchanged or the rotation speed is zero, performing the step 13a of determining whether a motionless time of the cart exceeds a predetermined time. When the processing module 131 of the server 130 or the processor 114 of the cart 110 judges the cart 110 does not move, the processing module 131 or the processor 114 begins to count the motionless time of the cart 110. The time counting for the motionless time of the cart 110 begins at the moment the cart 110 stops moving and stops at the moment the cart 110 starts moving or the time counting exceeds a predetermined time, wherein the predetermined time is set by supermarket worker. Once the motionless time of the cart 110 does not exceed the predetermined time, which represents the user of the cart 110 is picking up or staring at the commodity that user is interested in. Therefore, performing the step 15 of judging the user is interested and the step 17 of data processing. The processing module 131 of the server 130 judges that the user of the cart 110 is interested in the commodity that is corresponded to the commodity-communicating module 120 adjacent to the cart 110. Besides, the processing module 131 of the server 130 accesses the commodity that is interested by the user into the user preference database 132 to record consuming preference of each of the users.

With reference to FIGS. 1 and 2, in the step 13a of judging whether the motionless time of the cart exceeds the predetermined time or not, once the motionless time of the cart 110 exceeds the predetermined time, which represents that the cart 110 stays for a while. Therefore, performing the step 13b of determining whether the user holds the cart with one hand or two hands. Determining whether the user holds the handle 111a with one hand or two hands on the basis of the sensing members 111b of the pushing portion 111. With reference to FIGS. 2 and 3, each of the sensing members 111b outputs a sensing signal to the communication apparatus 113 separately, and the sensing signal outputted by each of the sensing members 111b may be high voltage level or low voltage level. The variation of the voltage level separately corresponds to whether the hands of the user touch the sensing members 111b or not. Next, the communication apparatus 113 transmits each of the sensing signals to the commodity-communicating module 120 via wireless communication, the commodity-communicating module 120 transmits the sensing signals to the processing module 131 of the server 130 via wireless or wired communication, and then the processing module 131 determines whether the user holds the handle 111a of the cart 110 with one hand or two hands on the basis of the sensing signals. Or, referring to FIGS. 2, 8 and 9, determining whether the user holds the handle 111a of the cart 110 with one hand or two hands on the basis of the sensing signal outputted by the sensing member 111b via the processor 114 of the cart 110. Next, the communication apparatus 113 of the cart 110 transmits the judged result of the processor 114 to the commodity-communicating module 120 via wireless communication, and the commodity-communicating module 120 transmits the judged result of the processor 114 to the processing module 131 of the server 130 via wireless or wired communication for the convenience of immediately controlling information that consumer uses the cart 110. Referring to FIGS. 2, 3, 8 and 9, in the step 13b of determining whether the user holds the cart with one hand or two hands, once the processing module 131 or the processor 114 judges the result that the user holds the handle 111a of the cart 110 with one hand or two hands, although the motionless time of the cart 110 exceeds the predetermined time, the user still uses the cart 110, which represents that the user is staying at a certain region and accepts promotion. Therefore, performing the step 13d of determining whether the number for holding the handle by the user with one hand or two hands exceeds a predetermined number of times, wherein whether the user holds the handle 111a repeatedly with one hand or two hands is sensed by the sensing members 111b of the pushing portion 111. Once the processing module 131 of the server 130 or the processor 114 of the cart 110 judges that the user holds the handle 111a, the processing module 131 or the processor 114 begins to start counting to the handle 111a of the cart 110 and stops till the user is away from the commodity region, wherein the predetermined number of times is set by supermarket worker. If the number for the user holding the handle 111a exceeds the predetermined number of times, which represents the user is not interested in the promotion within the commodity region therefore repeatedly holding and releasing the handle 111a. Oppositely, if the number for the user holding the handle 111a does not exceed the predetermined number of times, which represents the user is interested in the commodity region. Therefore, performing the step 15 of judging the user is interested and the step 17 of data processing, wherein the processing module 131 of the server 130 judges that the user of the cart 110 is interested in the commodity that is corresponded to the commodity-communicating module 120 adjacent to the cart 110, and the processing module 131 of the server 130 accesses the commodity that the user is interested in into the use preference database 132 to record consuming preference of each of the users.

With reference to FIGS. 1, 2, 3, 8 and 9, in the step 13b of determining whether the user holds the handle with one hand or two hands, once the processing module 131 or the processor 114 judges that no user holds the handle 111a of the cart 110 with one hand or two hands and the motionless time of the cart 110 exceeds the predetermined time, which represents there is no user using the cart 110. Therefore, performing the step 13c of recycling the cart, wherein the server 130 notices supermarket worker to recycle the cart 110. By communication between the communication apparatus 113 and the commodity-communicating module 120, the approximately position the cart 110 ceases moving within the supermarket is learned so that the time for recycling the cart 110 by supermarket worker is well reduced.

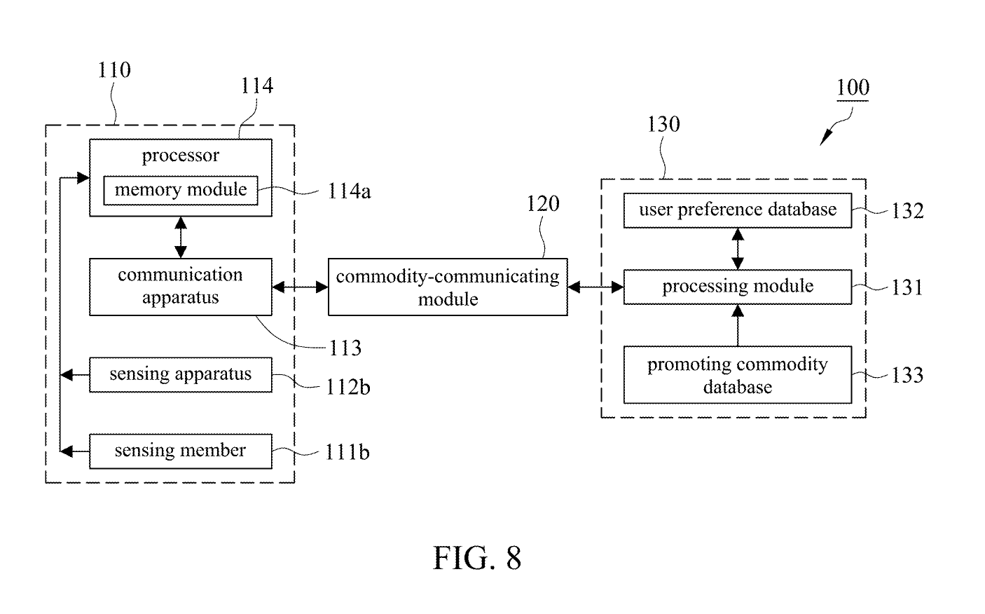

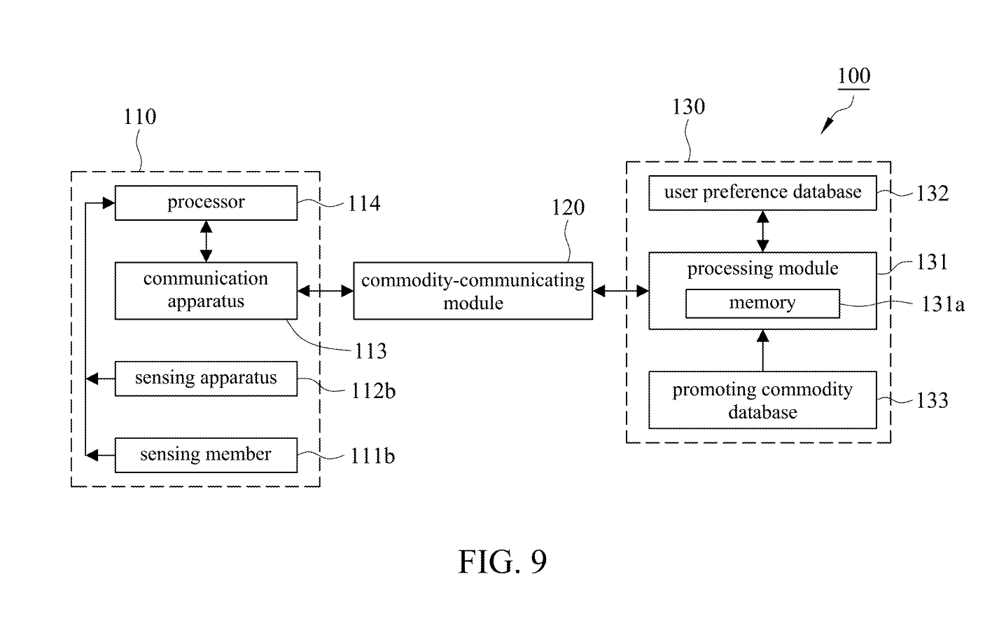

With reference to FIGS. 1, 2, 3, 8 and 9, in the step 13 of determining whether the cart moves or not, the processing module 131 or the processor 114 judges the movement of the cart 110 on the basis of the moving sense signal. That is to say, when variation of gravity is larger or rotation speed is larger than zero, performing the step 14 of determining whether the cart passes through the repeating area or not. In the step 13 of determining whether the cart moves or not, the serial number or node name of the commodity-communicating module 120 passed through by the cart 110 is stored in the memory module 114a of the processor 114 or the memory 131a of the processing module 131 of the server 130. Preferably, the setting merely stores several newest data from the commodity-communicating module 120 such as merely storing three data from the commodity-communicating module 120. Once the cart 110 passes through another commodity-communicating module 120, the oldest data in the memory module 114 or in the memory 131a will be overwritten by the new data of the commodity-communicating module 120, which represents the cart 110 does not pass through the repeating area. Oppositely, once the data of the commodity-communicating module 120 that is passed through by the cart 110 later is duplicate with the data recalled in the memory module 114a of the processor 114 or in the memory 131a of the server 130, which represents the cart 110 passes through the same area again, and the user is interested in the commodity within the repeating area. Therefore, performing the step 15 of judging the user is interested and the step 17 of data processing. With reference to FIGS. 3 and 8, the communication apparatus 113 of the cart 110 transmits the duplicate serial number or node name of the commodity-communicating module 120 to the commodity-communicating module 120, then the commodity-communicating module 120 transmits the data to the processing module 131 of the server 130, and the processing module 131 of the server 130 judges that the user of the cart 110 is interested in the commodity that is corresponded to the duplicate commodity-communicating module 120. In addition, the processing module 131 of the server 130 accesses the data of the commodity that the user is interested in into the user preference database 132 for recording the consuming preference of each of the users. Or, referring to FIG. 9, the processing module 131 of the server 130 accesses the duplicate serial number or node name of the commodity-communicating module 120 into the memory 131a of the processing module 131, and the processing module 131 judges that the user of the cart 110 is interested in the commodity that is corresponded to the duplicate commodity-communicating module 120. In addition, the processing module 131 of the server 130 accesses the data of the commodity that the user is interested in into the user preference database 132 for recording the consuming preference of each of the users.

With reference to FIGS. 1, 2, 3, 8 and 9, in the step 14 of determining whether the cart passes through the repeating area, once the cart 110 is determined to not pass through the repeating area, then performing the step 14a of determining whether the user pushes the cart with one hand or two hands. The sensing members 111b of the pushing portion 111 determines whether the user pushes the cart 110 with one hand or two hands, wherein the method for determining whether the user holds the handle 111a of the cart 110 is the same with the step 13b of determining whether the user holds the cart with one hand or two hands mentioned above. Accordingly, there is no need to give further description. In the step 14a of determining whether the user of the cart pushes the cart with one hand or two hands, once the user pushes the cart 110 with two hands, which represents the user merely pushes the cart 110 and passes through the commodity-communicating module 120. Therefore, the processing module 131 of the server 130 judges that the user is not interested in the commodity that is corresponded to the commodity-communicating module 120 adjacent to the cart 110.

With reference to FIG. 1, in the step 14a of determining whether the user of the cart pushes the cart with one hand or two hands, once the user pushes the cart 110 with one hand, which represents one hand of the user is pushing the cart 110, and the other hand of the user is taking the commodity. Therefore, performing the step 15 of judging the user is interested and the step 17 of data processing, wherein the processing module 131 of the server 130 judges that the user of the cart 110 is interested in the commodity that is corresponded to the commodity-communicating module 120 adjacent to the cart 110. Besides, the processing module 131 of the server 130 accesses the commodity the user is interested in into the user preference database 132 for recording the consuming preference of each of the users.

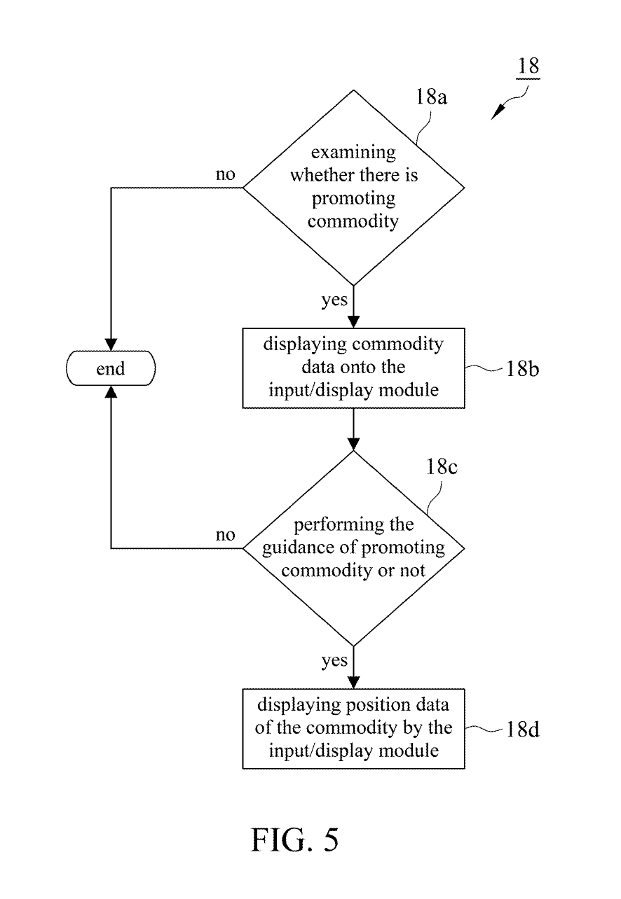

With reference to FIG. 1, repeatedly performing the step 13 of determining whether the cart moves or not after the step 17 of data processing for continuously recording shopping pattern of the user. Preferably, performing the step 18 of notifying for promoting commodity data after the step 17 of data processing. Referring to FIG. 5, the step 18 of notifying for promoting commodity data further includes the step 18a of examining whether there is promoting commodity, the step 18b of displaying commodity data onto the input/display module, the step 18c of performing the guidance of promoting commodity or not and the step 18d of displaying position data of the commodity by the input/display module. In the step 18 of notifying for promoting commodity data, the server 130 analyzes whether at least one commodity is in promotion under a category of the commodity that the user is interested in based on the user preference database 132 and the data of a promoting commodity database 133. Once at least one commodity is in promotion under the category of the commodity that the user is interested in, the server 130 transmits the data of the commodity in promotion to the cart 110 using by the user to display the data onto the input/display module 115 for waiting the user to choose. If the user chooses the data of the commodity in promotion, then the input/display module 115 will display the position data of the commodity in promotion to provide the user to proceed towards the position. Preferably, the processor 114 of the cart 110 indicates the route from the user of the cart 110 to the commodity in promotion onto the input/display module 115 on the basis of map data of the supermarket. Or the processor 114 navigates the cart 110 to the right position via the input/display module 115 for making the user arriving at the area of the commodity in promotion more rapidly. Additionally, once the user is not in the supermarket, the server 130 may notify the user for data of promoting commodity via APP of mobile apparatus or message.

By sensing whether the cart 110 moves or not via the sensing apparatus 112b, determining whether the motionless time of the cart 110 exceeds the predetermined time or not, determining whether the cart 110 passes through the repeating area or not via communication between the communicating apparatus 113 of the cart 110 and the commodity-communicating module 120, and determining whether the user holds the handle 111a with one hand or two hands via the sensing member 111b of the pushing portion 111, the present invention enables to judge about whether the user is interested in the commodity that is corresponded to the commodity-communicating module 120 adjacent to the cart 110 so as to perform individual shopping pattern analysis for each of the users. Therefore, it is more customized for the notices of commodities that are in promotion. Further, the notices of promotion commodities received by consumers will meet the needs of each consumer therefore stimulating consumption.

While this invention has been particularly illustrated and described in detail with respect to the preferred embodiments thereof, it will be clearly understood by those skilled in the art that is not limited to the specific features shown and described and various modified and changed in form and details may be made without departing from the spirit and scope of this invention.

1. A method for analyzing shopping pattern includes:
providing a shopping pattern analyzing system having a cart and at least one commodity-communicating module, wherein the cart comprises a pushing portion, a moving portion and a communication apparatus, the pushing portion comprises a handle and two sensing members disposed at the handle, the moving portion comprises a moving member and a sensing apparatus, and the at least one commodity-communicating module corresponds to a commodity;
determining whether the cart moves or not via the sensing apparatus, if the cart does not move, determining whether a motionless time of the cart exceeds a predetermined time or not, if the cart moves, determining whether the cart passes through a repeating area or not;
determining whether the motionless time of the cart exceeds the predetermined time or not, if not, judging a user of the cart is interested in the commodity that is corresponded to the at least one commodity-communicating module adjacent to the cart;
determining whether the cart passes through the repeating area or not, if yes, judging the user of the cart is interested in the commodity that is corresponded to the at least one commodity-communicating module within the repeating area, if not, judging the user pushes the cart with one hand or two hands; and
determining whether the user pushes the cart with one hand or two hands via the sensing members of the pushing portion by determining whether or not the user presses on one or both of the sensing members, if the user pushes the cart with two hands, judging the user is not interested in the commodity that is corresponded to the at least one commodity-communicating module adjacent to the cart, if the user pushes the cart with one hand, judging the user is interested in the commodity that is corresponded to the at least one commodity-communicating module adjacent to the cart.

2. The method for analyzing shopping pattern in accordance with claim 1, wherein in the step of determining whether the motionless time of the cart exceeds the predetermined time or not, if the motionless time of the cart exceeds the predetermined time, then determining whether the user holds the handle with one hand or two hands via the sensing members of the pushing portion, if yes, determining whether the number of times for holding and releasing the handle by the user with one hand or two hands exceeds a predetermined number of times, if not, recycling the cart.

3. The method for analyzing shopping pattern in accordance with claim 2, wherein in the step of determining whether the number of times for holding and releasing the handle by the user with one hand or two hands exceeds the predetermined number of times, if yes, judging the user is not interested in the commodity that is corresponded to the at least one commodity-communicating module adjacent to the cart, if not, judging the user is interested in the commodity that is corresponded to the at least one commodity-communicating module adjacent to the cart.

4. The method for analyzing shopping pattern in accordance with claim 1, wherein the cart further comprises an input/display module used for inputting and displaying data.

5. The method for analyzing shopping pattern in accordance with claim 4, wherein prior to the step of determining whether the cart moves or not via the sensing apparatus, further includes a step of inputting data of the user into the input/display module by the user of the cart.

6. The method for analyzing shopping pattern in accordance with claim 1, wherein the step of determining whether the cart passes through the repeating area or not is to make the data of the at least one commodity-communicating module that the cart passes through storing into a processor of the cart, then determine whether the data of the at least one commodity-communicating module that the cart passes through overlaps with the data in the processor or not, if yes, judging the cart did pass through the repeating area.

7. The method for analyzing shopping pattern in accordance with claim 4 further includes a data processing step, wherein the data processing step represents that a server accesses the commodity the user is interested in into a user preference database.

8. The method for analyzing shopping pattern in accordance with claim 7 further includes a step of notifying for promoting commodity data including:
examining whether there is promoting commodity, wherein the server analyzes whether at least one commodity is in promotion under a category of the commodity that the user is interested in based on the user preference database and the data of a promoting commodity database;
transmitting the data of the commodity in promotion to the cart used by the user and displaying the data onto the input/display module if the at least one commodity is in promotion under a category of the commodity that the user is interested in; and
performing the guidance of promoting commodity or not, wherein when the data of the commodity in promotion indicates onto the input/display module, once the user chooses the data of the commodity in promotion via the input/display module, then the input/display module displays the position data of the commodity in promotion.

9. An analyzing shopping pattern system includes:
a cart having a pushing portion, a moving portion and a communication apparatus, wherein the pushing portion comprises a handle and two sensing members disposed at the handle, the moving portion comprises a moving member and a sensing apparatus;
at least one commodity-communicating module linked with the communication apparatus of the cart via wireless communication, wherein the at least one commodity-communicating module corresponds to a commodity; and
a server linked to the at least one commodity-communicating module via wireless or wired communication, wherein the server comprises a processing module and a user preference database, the processing module determines whether a user of the cart is interested in the commodity based on whether one or both of the sensing members are pressed by the user and a moving condition sensed by the sensing apparatus, the user preference database is used for storing the data of the commodity that the user is interested in.

10. The analyzing shopping pattern system in accordance with claim 9, wherein the cart comprises an input/display module used for inputting and displaying data.

11. The analyzing shopping pattern system in accordance with claim 9, wherein the server comprises a promoting commodity database used for storing the data of the commodity in promotion.
